(19) United States
(12) Patent Application Publication
(10) Pub. No.: US 2010/0239183 A1
(43) Pub. Date: Sep. 23, 2010

(54) METHOD AND A DEVICE FOR PRODUCING A COMPOSITE IMAGE OR A COMPOSITE SEQUENCE OF IMAGES INDUCING ENHANCED PERCEPTION OF THE RELIEF OF AT LEAST ONE SUBJECT

(76) Inventor: Olivier Martinet, Lyon (FR)

Correspondence Address: CLARK & BRODY, 1700 Diagonal Road, Suite 510, Alexandria, VA, 22314, US

(21) Appl. No.: 12/663,111

(22) PCT Filed: Jun. 6, 2008
(86) PCT No.: PCT/FR08/51010

§ 371 Date: Jun. 1, 2010

(30) Foreign Application Priority Data
Jun. 6, 2007 (FR) 0755521

(51) Int. Cl. G06K 9/36

(52) U.S. Cl. 382/284

(57) ABSTRACT

The method and the device of the invention enables still or animated composite images to be produce that induce an enhanced perception of the relief of at least one subject by using a tiling to merge, for each composite image, a first initial or secondary image and a second initial or secondary image in such a manner that at least in the zone of the subject one tile in every two tiles in the composite image comes from the first initial or secondary image and one tile in every two tiles comes from the second initial or secondary image, the tiles coming from the first and second secondary images being arranged in a checkerboard pattern in the composite image.

The present invention relates to the technical field of so-called “in relief” images offering enhanced perception of perceptives and volumes.

In the above field, it is known to make use of so-called “stereoscopic” methods that make use of two distinct images of the same scene as seen from two spaced-apart points of observation, and that make use of special devices that enable spectators wearing special eyeglasses to have a perception of relief when viewing the images simultaneously, which images may be still or animated.

Those stereoscopic methods do indeed enable a spectator to have an impression of relief, but they present the drawback of requiring special projection installations that are particularly expensive and that make such methods difficult to use on a wide scale. Furthermore, in certain circumstances, the use of special eyeglasses can be troublesome for users.

There is therefore a need to have a method that enables a perception of relief to be augmented without having recourse to special viewing or projection systems, in particular for animated images or cinema films.

To achieve this object, the invention provides a method of producing a composite image inducing enhanced perception of the relief of at least one subject, the method comprising the following steps:
implementing a first initial image of the subject in a context;
implementing a second initial image of the same subject in the same context, offering an angle of observation of the subject that differs from the angle of observation of the first initial image;
optionally extracting from the first initial image a first secondary image that presents dimensions smaller than or equal to the dimensions of the first initial image and that incorporates the subject;
optionally extracting from the second initial image a second secondary image that presents dimensions smaller than or equal to the dimensions of the second initial image and that incorporates the subject;
implementing tiling of the initial and/or secondary images;
creating the composite image by merging the first and second initial and/or secondary images in such a manner that at least in the zone of the subject, one tile in two of the composite image comes from the first initial or secondary image, and one tile in two comes from the second initial or secondary image, the tiles from the first and second secondary and/or initial images being arranged in a checkerboard pattern in the composite image; and
optionally recording the composite image.

Surprisingly, viewing the composite image gives the observer a sensation of relief or a perception of relief that is quite clearly better than that produced by observing the first initial image or the second initial image. In the opinion of the Applicant, this enhanced perception of relief is the result of the way in which the brain constructs relief. When an observer having two healthy eyes looks at a subject, the brain receives simultaneously the image perceived by the left eye and the image perceived by the right eye. Although these images are practically identical, they nevertheless present small variations or offsets that are the result of the spacing between the left and right eyes. This spacing gives rise in particular to variations in color and brightness between the left image and the right image. By accurately superposing the two images, at least in the zone of the subject, and by eliminating one tile in two from each of the two images so as to obtain an image that is made up of half of the left image and half of the right image, the offsets in the values of the tiles as juxtaposed in this way are perceived as a checkerboard by the observer. When the size of the tiles is small, optical mixing takes place and the zones of the image will appear to flicker to a greater or lesser extent depending on the differences in contrast between the juxtaposed tiles. This flickering is interpreted by the brain as information about relief and thus gives rise to an increased perception of relief when observing the composite image of the invention.

According to the invention, the optional recording of the composite image may be performed in various ways, such as for example printing the composite image on a medium, recording the composite image on a magnetic or an electronic medium, or indeed recording the composite image on a film, or by any appropriate means.

According to the invention, the first and second initial images may be obtained in various ways, and for example they may correspond to two images initially taken from two different viewpoints, or they may correspond to two images taken one after the other with movement of the camera and of the subject relative to each other, or indeed the second image may be calculated or constructed from the first image in such a manner as to obtain an angle of observation that is different from that of the first image.

According to the invention, the first initial or secondary image and the second initial or secondary image may be merged over the entire surface area of both of the initial and/or secondary images or over a portion only of said area, depending on the looked-for effects and/or on the technical means used.

Thus, according to a characteristic of the invention, the method of producing a composite image further comprises the following steps:
defining a working window of dimensions smaller than or equal to the dimensions of the first initial image; and
extracting the first secondary image to the dimensions of the working window.

As mentioned above, the working window may thus correspond to all or to a part only of the first initial image, and likewise the first secondary image could, as a function of the dimensions of the working window, possess an area equivalent to that of the first initial image or smaller than said area. It should be observed that in a preferred implementation of the method, the first and second initial images present dimensions and shapes that are identical, but that is not strictly necessary. Thus, according to a characteristic of the method of the invention for producing a composite image, the second secondary image presents the same dimensions as the first secondary image.

Similarly, the shape of the working window may be varied, and for example it may be adapted as a function of the shape of the subject(s) presenting relief that is to be enhanced. Nevertheless, in a preferred implementation, the shape of the working window is selected to be rectangular.

According to another characteristic of the invention, the method of producing a composite image includes a step of defining the fineness of the tiling. This definition of the fineness of the tiling serves to accentuate to a greater or lesser extent the relief effect that is obtained by merging the images.

In the invention, the tiling may present a structure of tiles of different shapes, insofar as said tile structure enables the images to be tiled in regular manner. Preferably, a regular tiling is adopted based on a tile of rectangular shape, and in more particularly preferred manner of square shape. The definition of the fineness of the tiling then consists in determining the dimension of the side of the tile that is adopted. According to a characteristic of the invention, the tiling adopted corresponds to breaking images down into pixels. This characteristic makes it possible in particular to match the tiling to the device used for viewing the composite image.

According to another characteristic of the invention, intended to compensate for large variations in the shape of the subject, in particular between the first and second initial images, the method of producing a composite image includes a step of deforming the second initial image or the second secondary image in such a manner as to cause the position in the tiling of reference points common to the first initial or secondary image and to the second initial or secondary image to coincide.

The invention also seeks to produce images that are still or animated and that offer enhanced perception of relief. Thus, the invention also provides a method of producing a composite animated sequence inducing an enhanced perception of the relief of at least one subject comprising at least a succession of composite images each obtained using the method of the invention.

In the invention, the initial images may come from different types of source, such as for example: films, videos, or indeed images or drawings made by computer.

In a first implementation of the method of producing a composite animated sequence, the first and second initial images at the origin of each composite image of the composite animated sequence are extracted from a single initial animated sequence comprising a succession of initial images of the subject in a context. This implementation of the method is more particularly adapted to producing a composite animated sequence from a film or from a monoscopic animated sequence.

According to a characteristic of this first implementation of the method of the invention for producing a composite animated sequence, two successive composite images of the composite animated sequence are produced from two first initial images corresponding to two successive images of the initial animated sequence and two second initial images each of which is offset in time relative to the corresponding first initial image and occurs later than the corresponding first initial image in the succession of initial images of the initial animated sequence.

It should be observed that, according to the invention, it is also possible to envisage calculating or generating each or some of the second initial images from the corresponding first initial images in order to make stereoscopic images, e.g. as proposed in the following documents: WO0039995, WO03105491, WO03105491A1, WO2005084298, WO2006004932, WO2006075325, WO2006078237, WO2006078249, and WO2006078250.

According to another characteristic of the first implementation of the method of the invention for producing a composite animated sequence, the method includes a step of defining a time offset between each first initial image and the second initial image that is associated therewith.

In a second implementation of the method of producing a composite animated sequence, the first and second initial images at the origin of each composite image of the composite animated sequence are extracted respectively from a first initial animated sequence comprising a succession of initial images of the subject in a context, and a second initial animated sequence comprising a succession of initial images of the subject in the same context, the second animated sequence offering an observation angle of the subject that is different from the observation angle of the first initial animated sequence.

This second implementation of the method is more particularly adapted to processing images made by a stereoscopic method.

According to a characteristic of this second implementation of the method of the invention for producing a composite animated sequence, the first and second initial animated sequences are synchronized with each other.

The invention also provides a method of producing at least one composite image and/or at least one composite animated sequence inducing an enhanced perception of the relief of at least one subject, the device comprising storage means and calculation means, and being characterized in that:
the storage means are adapted to record initial images, at least temporarily; and
in that the calculation means are adapted to implement a production method of the invention and to produce the composite image and/or the composite animated sequence from initial images recorded in the storage means, and also optionally to proceed with recording, at least temporarily, the composite image and/or animated sequence in the storage means.

By way of example, such a device may be constituted by a workstation or a personal computer performing all or part of the operations or steps of the method of the invention under the control of an operator. Such a device may also be constituted by a system operating automatically without requiring any particular supervision.

Thus, according to a characteristic of the invention, the calculation means of the device for producing at least one composite image and/or at least one composite animated sequence are adapted to produce the composite image and/or the composite animated sequence in real time.

According to a characteristic of the invention, the device is adapted to produce composite images or composite animated sequences from initial monoscopic images or sequences that are broadcast by wire or wirelessly. For this purpose, the device of the invention includes means for receiving initial images. Such receiver means may comprise an interface for connection to a wired network or indeed an interface for radio reception.

According to a characteristic of the invention, the device is adapted to play back composite images or composite animated image sequences that it generates. For this purpose, the device in accordance with the invention, it includes means for playing back the composite image and/or the composite animated sequence. These playback means may, for example, comprise a video interface for connection to a screen or a projector. These playback means may also be constituted by a screen as such or by a unit for playing back composite images from a wired or wireless network.

According to yet another characteristic of the invention, the device of the invention for producing at least one composite image and/or at least one composite animated sequence includes means for defining tiling implemented in the production of the composite image and/or the composite animated sequence. Such means may for example be constituted by an interface enabling a user to select the size and/or the form of the tiling that is used. Such tiling-defining means then enable the user to determine the result that is obtained according to taste.

On the same lines and according to another characteristic of the invention, the device for producing at least one composite image and/or at least one composite animated sequence includes means for defining a time offset for computing the composite animated sequence from an initial animated sequence.

Naturally, the various above-mentioned characteristics of the invention may be implemented together with one another in various combinations, providing they are not incompatible or mutually exclusive.

Furthermore, various other characteristics of the invention appear from the following description given with reference to the accompanying drawings that show embodiments and implementations of the invention as non-limiting examples.

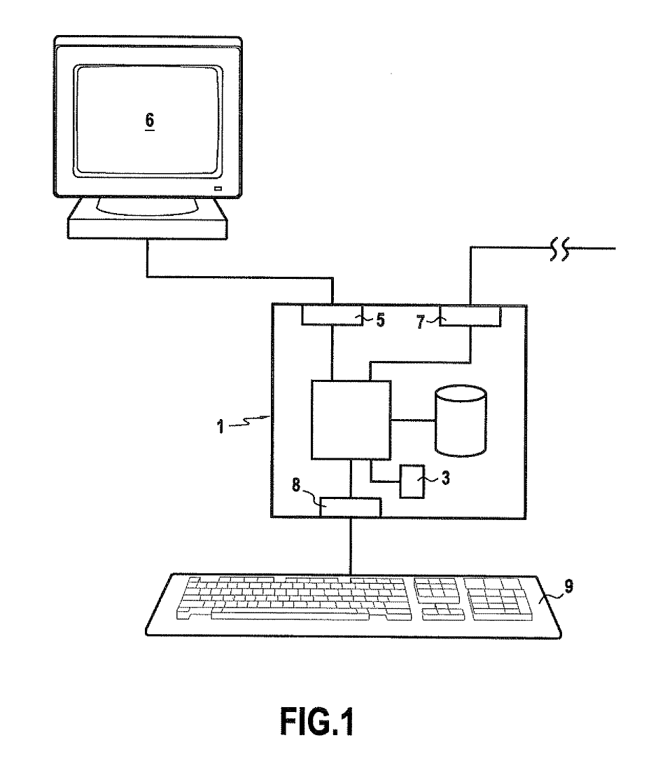

FIG. 1 is a diagram of a device for producing a composite animated sequence in accordance with the invention.

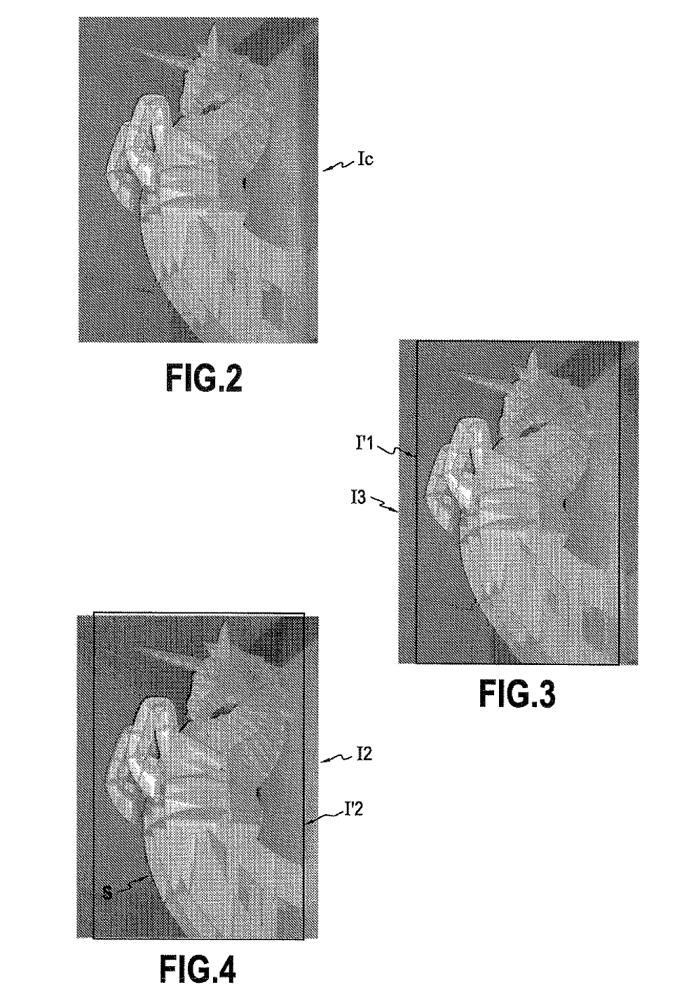

FIG. 2 is an example of a composite image obtained by implementing the method of the invention.

FIG. 3 is a first initial image used in producing the composite image of FIG. 2;

FIG. 4 is a second initial image used for producing the composite image of FIG. 2.

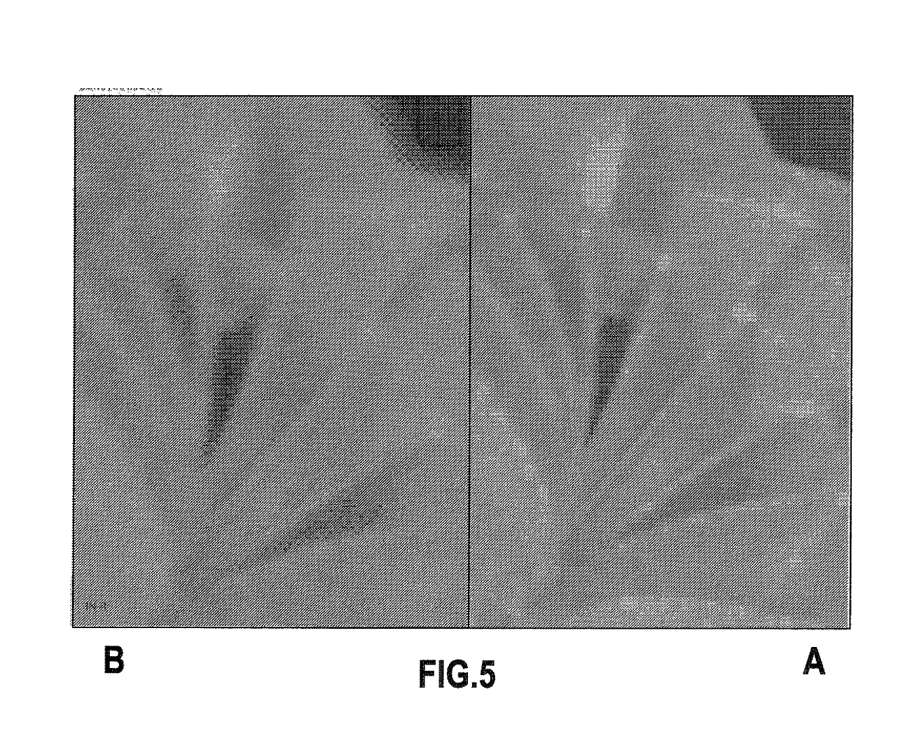

FIG. 5 is a juxtaposition of enlargements of a detail, identified by a dotted outline box in FIG. 2, portion A corresponding to the first initial image and portion B corresponding to the composite image.

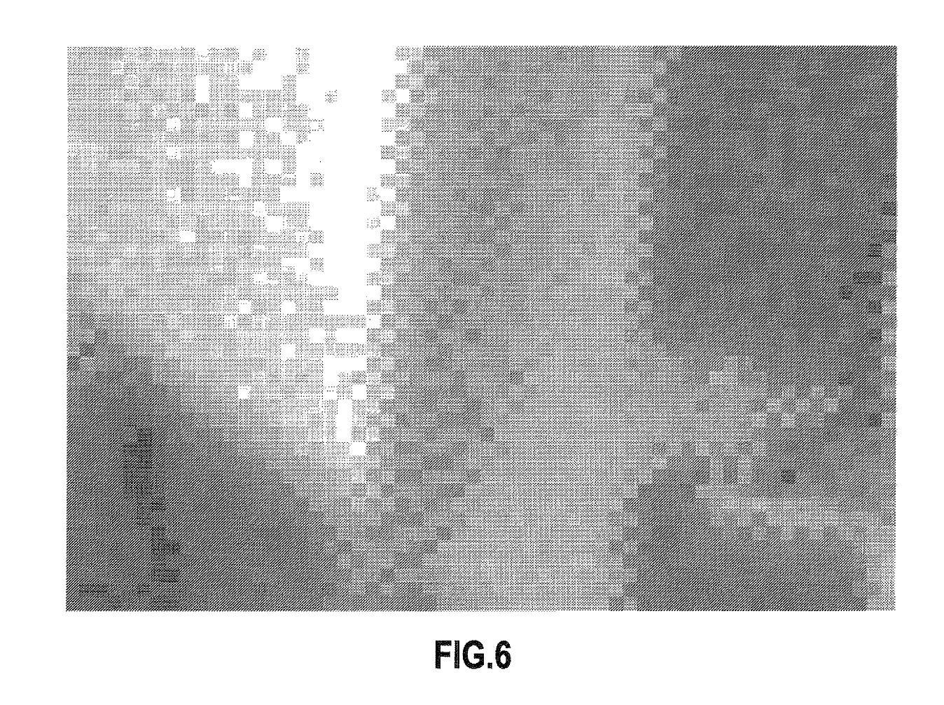

FIG. 6 is an enlargement on a larger scale of the composite image showing the tiling that is implemented.

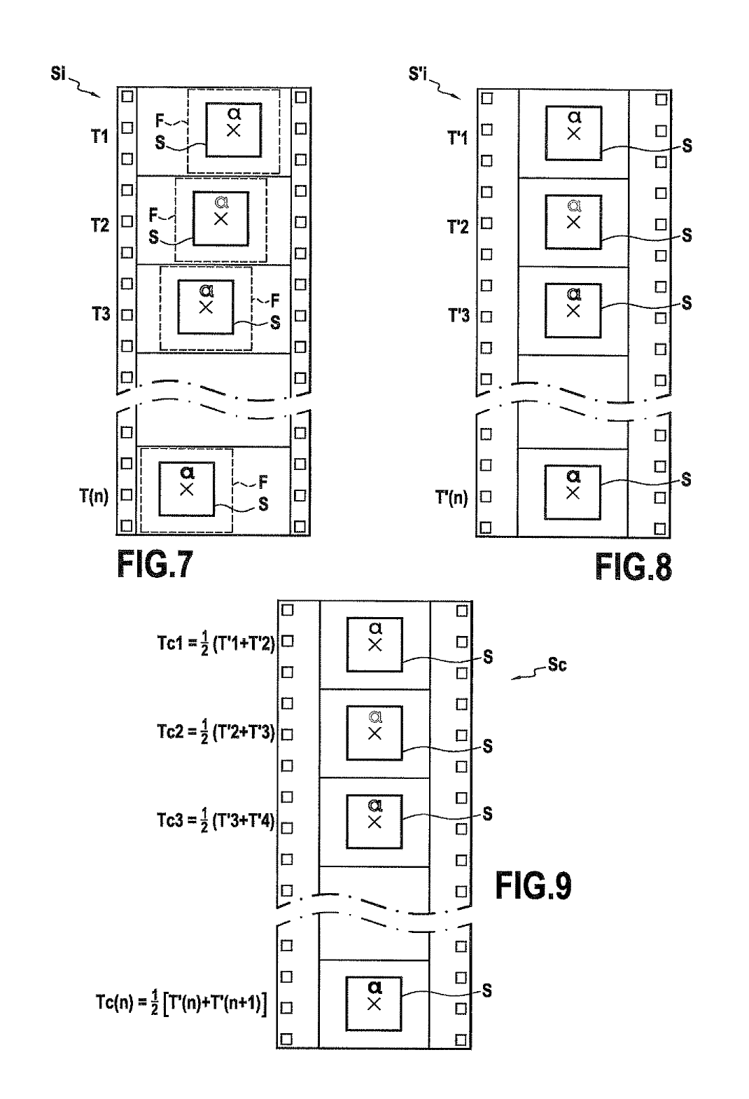

FIG. 7 is a diagram of an initial animated sequence used for generating a composite animated sequence.

FIG. 8 is a diagram of a secondary animated sequence generated from the initial animated sequence shown in FIG. 7.

FIG. 9 is a diagram of a composite animated sequence obtained from the initial animated sequence shown in FIG. 7.

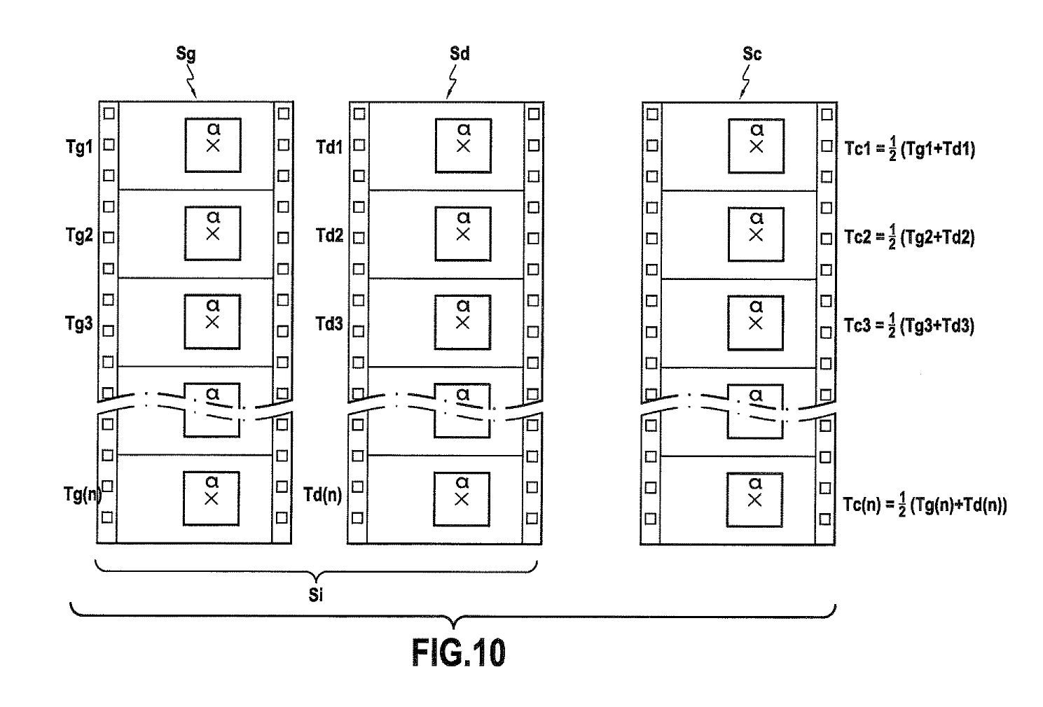

FIG. 10 is a diagram of a method of the invention for generating a composite animated sequence from initial left and right animated sequences of an initial stereoscopic animated sequence.

The invention seeks to enable composite images to be made by means of a device as shown diagrammatically in FIG. 1 and given overall reference 1. By way of example the device 1 is constituted by a personal computer central unit including a calculation unit 2 connected to storage means such as a random access memory (RAM) unit 3 and a hard disk unit 4. The calculation unit 2 is also connected to a playback unit such as a video interface 5 connected to a monitor 6. The device 1 also includes receiver means 7, such as a wired network interface. The calculation unit is also connected to a data input interface 8 connected to a keyboard 9 that may be used as means for defining a tiling or a time offset.

After loading a computer program for implementing the composite image production method in accordance with the invention, the device 1, and more particularly the calculation unit 2, is adapted to produce a composite image Ic as shown in FIG. 2 from a first initial image I1 and a second initial image I2, shown respectively in FIGS. 3 and 4.

By way of example, the initial images I1 and I2 are stored in the storage means 4. The initial images I1 and I2 correspond to two views of the same subject S taken from slightly different angles, the subject S here being a sculpture of a unicorn. The method of the invention proposes merging the initial images I1 and I2 so as to obtain the composite image Ic that offers an enhanced perception of relief. To this end, two secondary images I′1 and I′2 are extracted from the initial images, the secondary images being of the same size as each other and smaller than the initial images I1 and I2. Each secondary image I′1 and I′2 corresponds to a working window, represented by continuous lines in FIGS. 3 and 4, the windows being placed in such a manner that the secondary images cover the subject for which perception of relief is to be enhanced. Once the extraction has been performed, identical tiling is applied to each of the secondary images I′1 and I′2, and in the present example the tiling has a rectangular basis and is performed at pixel scale, as shown in FIGS. 5 and 6. The composite image Ic is then obtained by using the two secondary images I′1 and I′2 in such a manner as to conserve only one tile in two in each of the two images, the tiles that are conserved being arranged in a checkerboard pattern, as can be seen more particularly in FIG. 6. Portion A of FIG. 5 shows an enlargement of a region of the first initial image I1 broken up into pixels, while portion B shows the corresponding region of the composite image Ic in which one in every two pixels comes from the first initial image I1, and more particularly from the first secondary image I′1, and in which every other pixel in two comes from the second initial image I2, and more particularly from the second secondary image I′2. FIG. 6 shows on a larger scale the checkerboard effect that results from using the secondary images I′1 and I′2 in accordance with the invention. Looking at FIG. 6 makes it possible to perceive the pixel flicker that is at the origin of the enhanced perception of relief in the composite image Ic. It should be observed that the method of the invention makes it possible to offer an enhanced perception of relief from a single image without making use of special viewing or projection devices.

The invention also proposes implementing methods of producing a composite image to make composite animated sequences that offer an enhanced perception of relief.

In one implementation, the invention enables said composite animated sequence to be made from an animated sequence of a film or a video made using traditional methods that enable a sequence to be obtained that is said to be “monoscopic” in that it is made from a single-lens camera or using a method of generation that simulates such a single-lens camera.

The initial animated sequence Si, shown diagrammatically in FIG. 7 comprises a succession of initial images T1, T2, T3, Tn of a subject S taken from different observation angles that vary as a result of either the camera or the subject moving.

From the initial animated sequence Si, there is extracted a secondary animated sequence S′i as shown diagrammatically in FIG. 8, in which each of the secondary images T′1, T′2, T′3, T′n is extracted from the corresponding initial image using a working window F, that in the example shown, is substantially centered on the subject S.

Thereafter, a composite animated sequence Sc, as shown in FIG. 9, is generated from the secondary animated sequence S′i, each composite image Tc1, Tc2, Tc3, Tc(n) of the composite animated sequence being obtained by merging a secondary image T′i(n) of the secondary animated sequence with the following secondary image T′i(n+1) after applying tiling in accordance with the above description. Thus, each composite image Tc(n) of the composite animated sequence Sc satisfies the following relationship:

Tc(n)=[T′i(n)+T′i(n+1)]/2

It should be observed that the merging of each first secondary image T′i(n) with each second secondary image T′i(n+1) to constitute each composite image of the animated sequence Tc(n) is performed in such a manner as to cause at least one reference point a that is common to both secondary images to coincide. In order to enable such coincidence to be achieved, it might be necessary to deform the second secondary image T′i(n+1), e.g. by subjecting it to morphing techniques.

In this example, there is a time offset of one image between the two secondary images used for generating each of the composite images of the composite animated sequence. Nevertheless, in the invention, it is possible to envisage adopting a greater time offset d in each composite image of the composite animated sequence, satisfying the following relationship:

Tc(n)=[T′i(n)+T′i(n+d)]/2

The operator or the user of the method would then have the possibility of selecting a value for the time offset as a function of the looked-for effect.

As can be seen in FIG. 10, the invention also proposes making a composite animated sequence Sc by using as the first image Tg1, Tg2, Tg3, . . . , Tg(n) and as the second image Td1, Td2, Td3, . . . , Td(n) for making up each composite image Tc1, Tc2, Tc3, . . . , Tc(n) of the composite animated sequence, images that are taken from initial left and right animated sequences Sg and Sd of an animated sequence Si that is made stereoscopically. Thus, each composite image Tc(n) of the composite animated sequence satisfies the relationship:

Tc(n)=[Tg(n)+Td(n)]/2

In accordance with the invention, each first image Tg1, Tg2, Tg3, . . . , Tg(n) is merged with each second image Td1, Td2, Td3, . . . , Td(n) to make up each composite image Tc1, Tc2, Tc3, . . . , Tc(n) after applying tiling and in such a manner as to cause the subject(s) S to coincide at least one reference point therein. Furthermore, the merging may be performed after optionally extracting a secondary image from each first image and each second image used to make up each composite image.

Naturally, within the ambit of the claims, various modifications may be applied to the method and the device of the invention for producing a composite image or a composite animated sequence.

1. A method of producing a composite image inducing enhanced perception of the relief of at least one subject, the method comprising the following steps:
implementing a first initial image (I1) of the subject in a context;
implementing a second initial image (I2) of the same subject in the same context, offering an angle of observation of the subject that differs from the angle of observation of the first initial image;
optionally extracting from the first initial image (I1) a first secondary image (I′1) that presents dimensions smaller than or equal to the dimensions of the first initial image (I1) and that incorporates the subject;
optionally extracting from the second initial image (I2) a second secondary image (I′2) that presents dimensions smaller than or equal to the dimensions of the second initial image (I2) and that incorporates the subject;
implementing tiling of the initial and/or secondary images;
creating the composite image (Ic) by merging the first and second initial and/or secondary images in such a manner that at least in the zone of the subject, one tile in two of the composite image comes from the first initial or secondary image, and one tile in two comes from the second initial or secondary image, the tiles from the first and second secondary and/or initial images being arranged in a checkerboard pattern in the composite image; and
optionally recording the composite image.

2. A method of producing a composite image according to claim 1, the method being characterized in that it comprises the following steps:
defining a working window of dimensions smaller than or equal to the dimensions of the first initial image (I1); and
extracting the first secondary image (I2) to the dimensions of the working window.

3. A method of producing a composite image according to claim 1, characterized in that the second secondary image (I′2) presents the same dimensions as the first secondary image (I′1).

4. A method of producing a composite image according to claim 1, characterized in that it includes a step of defining the fineness of the tiling.

5. A method of producing a composite image according to claim 1, characterized in that the tiling adopted corresponds to breaking images down into pixels.

6. A method of producing a composite image according to claim 1, characterized in that it includes a step of deforming the second initial image (I2) or the second secondary image (I′2) in such a manner as to cause the position in the tiling of reference points common to the first initial or secondary image and to the second initial or secondary image to coincide.

7. A method of producing a composite animated sequence (Sc) inducing an enhanced perception of the relief of at least one subject comprising at least a succession of composite images each obtained using the method according to claim 1.

8. A method of producing a composite animated sequence according to claim 7, characterized in that the first and second initial images at the origin of each composite image (Tc(n)) of the composite animated sequence (Sc) are extracted from a single initial animated sequence (Si) comprising a succession of initial images (T(n)) of the subject (S) in a context.

9. A method of producing a composite animated sequence according to claim 8, characterized in that two successive composite images of the composite animated sequence are produced from two first initial images corresponding to two successive images of the initial animated sequence and two second initial images that are offset in time relative to the corresponding first initial images and that occur later than the corresponding first initial images in the succession of initial images of the initial animated sequence.

10. A method of producing a composite animated sequence according to claim 8, characterized in that it includes a step of defining a time offset (d) between each first initial image and the second initial image that is associated therewith.

11. A method of producing a composite animated sequence according to claim 7, characterized in that the first and second initial images at the origin of each composite image of the composite animated sequence (Sc) are extracted respectively from a first initial animated sequence (Sg) comprising a succession of initial images of the subject in a context, and a second initial animated sequence (Sc) comprising a succession of initial images of the subject in the same context, the second animated sequence offering an observation angle of the subject that is different from the observation angle of the first initial animated sequence.

12. A method of producing a composite animated sequence according to claim 11, characterized in that the first and second initial animated sequences (Sg and Sd) are synchronized with each other.

13. Device for producing at least one composite image and/or at least one composite animated sequence inducing an enhanced perception of the relief of at least one subject, the device comprising storage means (3, 4) and calculation means (2), and being characterized:
in that the storage means (3, 4) are adapted to record initial images, at least temporarily; and
in that the calculation means (2) are adapted to implement a production method according to claim 1 and to produce the composite image and/or the composite animated sequence from initial images recorded in the storage means, and also optionally to proceed with recording, at least temporarily, the composite image and/or animated sequence in the storage means (3, 4).

14. A device for producing at least one composite image and/or at least one composite animated sequence according to claim 13, characterized in that the calculation means (2) are adapted to produce the composite image and/or the composite animated sequence in real time.

15. A device for producing at least one composite image and/or at least one animated sequence according to claim 13, characterized in that it includes means (7) for receiving initial images.

16. A device for producing at least one composite image and/or at least one composite animated sequence according to claim 13, characterized in that it includes means (5, 6) for playing back the composite image and/or the composite animated sequence.

17. A device for producing at least one composite image and/or at least one composite animated sequence according to claim 13, characterized in that it includes means (9) for defining tiling implemented in the production of the composite image and/or the composite animated sequence.

18. A device for producing at least one composite image and/or at least one composite animated sequence according to claim 13, characterized in that it includes means (9) for defining a time offset for computing the composite animated sequence from an initial animated sequence.
